(19) United States
(12) Patent Application Publication
(10) Pub. No.: US 2011/0032423 A1
(43) Pub. Date: Feb. 10, 2011

(54) ADAPTIVE USER PROFILING FOR TV-CENTRIC HOME AUTOMATION SYSTEM

(75) Inventors: XIANGPENG JING, San Diego, CA (US); ABHISHEK PATIL, San Diego, CA (US); NOBUKAZU SUGIYAMA, San Diego, CA (US); LING JUN WONG, Escondido, CA (US); DIPENDU SAHA, San Diego, CA (US); DJUNG NGUYEN, San Diego, CA (US)

Correspondence Address: ROGITZ & ASSOCIATES, 750 B STREET, SUITE 3120, SAN DIEGO, CA, 92101, US

(73) Assignees: SONY CORPORATION; SONY ELECTRONICS, INC.

(21) Appl. No.: 12/537,091

(22) Filed: Aug. 6, 2009

(51) Int. Cl. H04N 7/00; H04N 5/44

(52) U.S. Cl. 348/552; 348/734; 348/E07.001; 348/E05.096

(57) ABSTRACT

A TV seamlessly connects to and controls home automation equipment such as lighting, audio/video control, climate control, etc. The TV provides users with a friendly UI to control the equipment, and furthermore the TV adapts to observed user behavior to automatically establish and change settings based thereon. In addition, based on the content watched (or mode selection) on the TV, the settings of surrounding lighting, temperature and other controlled appliance would be changed by the TV.

### FIELD OF THE INVENTION

The present application relates generally to adaptive user profiling for TV-centric home automation systems.

### BACKGROUND

Home automation systems have been provided to control various home appliances, e.g., lighting, home theater sound systems, and environmental control systems such as heating and air conditioning. As understood herein, home automation systems typically require a user desiring a particular setting on a particular appliance to manually enter information into a central controller each time a user wishes to change a setting. This is tedious and moreover fails to account for the present recognition that a user may wish for a particular set of settings for a particular time of day, and another set for another time of day, thus requiring perpetual user intervention in the system to achieve the desired settings.

### SUMMARY OF THE INVENTION

TV, as the center of the home automation system controller, can provide a unified User Interface to show all connected wireless sensor-equipped devices at home. A user can use a TV remote to click into each sensor-equipped device in a home and change its settings, such as turn on/off a light, adjust room temperature, turn on/off doors or window blinds, adjust audio device volume, etc. The control interface to users can also be implemented using alternative methods (or combinations) such as voice recognition where users can speak out the command they want, or gesture recognition (if a camera device presents) where users use hands to point to target device and show commands (e.g., up/down).

Accordingly, a system includes a TV display, a TV processor controlling the display and accessing a computer readable storage medium, and a control communication interface communicating with the TV processor. The control communication interface may be a standard networking interface (wireless or Ethernet) connecting directly to wireless sensors or via an external controller device. A lighting controller controls energization and/or brightness of one or more lamps in a home, and the TV processor communicates with the lighting controller using the control communication interface to control the lighting controller to establish settings for the lamp. Also, a home theater controller controls at least one home theater component and communicates with the TV processor through the control communication interface, with the TV processor controlling the home theater controller to establish at least one setting for a home theater such as speaker volume, bass, etc. Moreover, a room temperature controller controls temperature of at least one room in a home in which the TV processor is disposed. The TV processor communicates with the room temperature controller using the control communication interface to control the room temperature controller to establish temperature settings. The TV processor adapts the settings for the lamp and/or the setting for the home theater and/or the temperature settings based on user behavior.

In example embodiments the TV processor establishes respective home system modes and appliance settings for each controller for each mode and controls the controllers to establish the appliance settings for the respective appliance based on a mode selection input to the TV processor. Also, in some embodiments the TV processor uses a wireless communication system to communicate with the controllers. The TV processor may adapt to user behaviors noted as input to the TV processor and/or sensed by controller sensors and communicated to the TV processor. The TV processor adapts to user behaviors by automatically establishing a mode and/or by automatically changing at least one appliance setting of a mode.

If desired, each mode can include respective appliance settings for a mixture of lighting controller, temperature controller and a home theater controller. The TV processor can automatically command appliance settings based on user interactions. As an example, TV may switch appliance settings to a home theater mode to be established by the controllers in response to receiving indication of engagement of an optical storage disk inserted to a disk player. In example implementations the TV processor automatically establishes a mode based on time of day in response to observed history user behavior, which may be recorded in TV on an hourly basis.

In another aspect, a system includes a TV display and a TV processor controlling the display and accessing a tangible computer readable storage medium bearing instructions. The instructions cause the processor to communicate with at least first and second home automation system controllers. The first controller controls a home appliance that does not send to the TV processor or receive from the TV processor audio/video information. The instructions also cause the TV processor to establish respective home system modes and appliance settings for each controller for each mode, and to control the controllers to establish the appliance settings for the respective appliance based on a mode selection input to the TV processor.

In another aspect, a TV includes a TV display, a processor communicating with the TV display, and a computer readable storage medium accessible to the processor and bearing logic to cause the processor to present on the display a user interface (UI) listing two or more home modes. Each mode is correlated to plural settings associated with respective plural home appliances. The processor receives user input through the UI representing user selection of a selected home mode and automatically establishes the settings associated with the selected home mode.

In another embodiment the ambient lighting in the house and temperature may be changed based on the theme of the content being watched on TV. For example, a thriller or a suspense movie may require dim light and lower temperature as compared to an action/adventure movie. The TV gathers the content information based on the meta-tag associated with it (or based on mode selection by the user).

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 is a screen shot of an example mode setting user interface (UI);

FIG. 3 is a flow chart of example set-up logic;

FIG. 4 is a flow chart of example adaptive mode settings change logic;

FIG. 5 is a screen shot of an example selection UI;

FIG. 6 is a flow chart of example behavior correlation logic; and

FIG. 7 is a flow chart of additional mode establishment logic.

### DETAILED DESCRIPTION OF THE PREFERRED EMBODIMENT

Referring initially to FIG. 1, a system 10 is shown that includes a TV 12 with TV chassis 14 bearing a TV display 16 such as but not limited to a flat panel matrix or plasma display. The display 16 is controlled by a TV processor 18 accessing a computer readable storage medium 20 to present video images from a selected video source such as a TV tuner 22 or other over the air broadcast receiver or disk player. Other sources of video may be provided, e.g., the Internet through an Internet interface 24, a home theater 26, a cable head end, etc.

The computer readable storage medium 20 may be solid state or disk-based storage containing data and instructions to the TV processor 18 to execute portions of the logic divulged below. It is to be understood that while FIG. 1 shows that the processor 18, medium 20, and TV tuner 22 are in the chassis 14, in alternate embodiments one or more of these components may be separately housed in, e.g., a set-top box.

Additionally, the TV 12 may include a wireless data communication interface 28 such as but not limited to a WiFi transceiver for communicating with a portable computer (PC) 30 in the home in which the TV 12 is disposed. The TV 12 may also include a control communication interface 32 such as a ZigBee interface as defined by the Z-Wave Alliance to communicate with smart home appliances such as the home theater 26, a lighting controller 34, a room temperature controller 36, and other appliance controllers 38 such as refrigerator controllers, security lock controllers, etc. Non-limiting examples of such controllers may be provided by Control4, ControlThink, etc. Wired paths may also or alternatively be used. A user can input wireless commands to the TV 12 using a portable remote control device 40 which transmits signals such as infrared (IR) signals to a wireless receiver 42 on the TV 12.

Turning to the details of an example non-limiting lighting controller 34, the lighting controller 34 is used to control the energization and/or brightness of one or more lamps 44 in the home. The lighting controller 34 typically contains a lighting processor 46 accessing a computer readable storage medium 48. Also, the lighting controller 34 includes a control communication interface 50 for communicating with the control communication interface 32 of the TV 12.

The example non-limiting home theater 26 may include a theater processor 52 accessing a computer readable storage medium 54. Also, the theater controller 26 includes a control communication interface 56 for communicating with the control communication interface 32 of the TV 12. The home theater 26 can include one or more receptacles for receiving one or more optical video disks for play by a disk player 58, for processing of data on the disk and sending resulting image information to the TV processor 18 for presentation on the TV display 16. Further, the home theater 26 may include one or more audio speakers and/or bass amplifier 60.

The example non-limiting room temperature controller 36 may include a temperature processor 62 accessing a computer readable storage medium 64. Also, the temperature controller 36 can include a control communication interface 66 for communicating with the control communication interface 32 of the TV 12. The controller 36 may include one or more temperature sensors 68 sending signals to the processor 62 for controlling a heater 70 and an air conditioning unit 72 to establish a desired room temperature in accordance with principles below.

The example non-limiting appliance controller 36 may include an appliance processor 74 accessing a computer readable storage medium 76. Also, the appliance controller 38 can include a control communication interface 78 for communicating with the control communication interface 32 of the TV 12. The controller 38 may include one or more appliance sensors 80 sending signals to the processor 74 for controlling the appliance. Without limitation an appliance sensor 80 may be a door lock sensor sensing whether a controlled door is open/closed/locked/unlocked, a temperature sensor, a light sensor, etc.

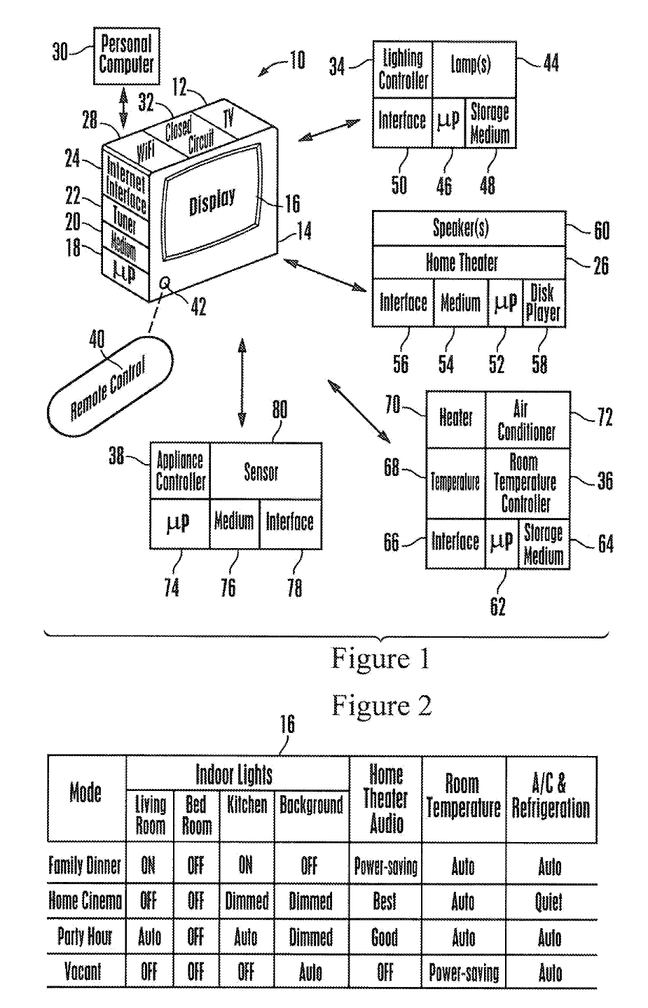

FIG. 2 shows an example screen shot of a UI that may be presented on the TV display 16 and accessible via a setup menu. As shown, the UI may include five main columns, the first one representing a “mode” name and the remaining four corresponding to the example controllers 34, 26, 36, 38 shown in FIG. 1. Each row of the UI indicates the setting for the particular mode and controller. In the case of the lighting column, sub-columns may be presented, one representing the lighting setting in a respective room in the house.

Thus, for example, default settings may be established for each mode and the UI of FIG. 2 then displayed to permit the user to alter the settings using, e.g., the cursor control keys of the remote control 40 shown in FIG. 1. In the non-limiting example of FIG. 2, in “Dinner” mode, the kitchen and living room lights are set to be on and other room are set to be off (or dim), meaning that the TV processor 18 commands the lighting controller 34 to establish the settings in FIG. 2. Also, in the dinner mode the TV processor 18 commands the home theater systems to assume a power-saving mode and the temperature controller 36 and appliance controller 38 to assume “automatic” control, i.e., to establish the settings that are locally input to the controllers 36, 38.

In contrast, in the example shown in FIG. 2, in the “Home Cinema” mode the TV processor 18 commands the lighting controller 34 to deenergize lights in the living room and bedroom and energize, but dim, the lights in the kitchen and to dim background lights (including, e.g., landscaping and security lights), if any, in the home. The home theater controller 26 is commanded to be in best performance mode, typically to output the highest fidelity sound available on the speakers 60. The TV controller 18 commands the room temperature controller 36 to be in “automatic” and the appliance controller 38 to assume a “quiet” mode, if available.

As shown in FIG. 2, in an example “Party” mode the TV processor 18 establishes automatic (local) settings for the living room and kitchen lights, causes the bedroom lights to be off and dims the background lighting, if any. The audio of the home theater 26 is caused to be set to “best” and the temperature controller 36 and appliance controller 38 are commanded to assume “automatic” control.

In an example “home vacant” mode all lights are caused to be turned off with the exception of background lighting, which may be set to “automatic”, i.e., to establish the lighting configuration input locally to the lighting controller 34. The home theater 26 is caused to assume the “off” configuration, room temperature is set to “power saving”, and the appliance controller 38 caused to assume the automatic mode.

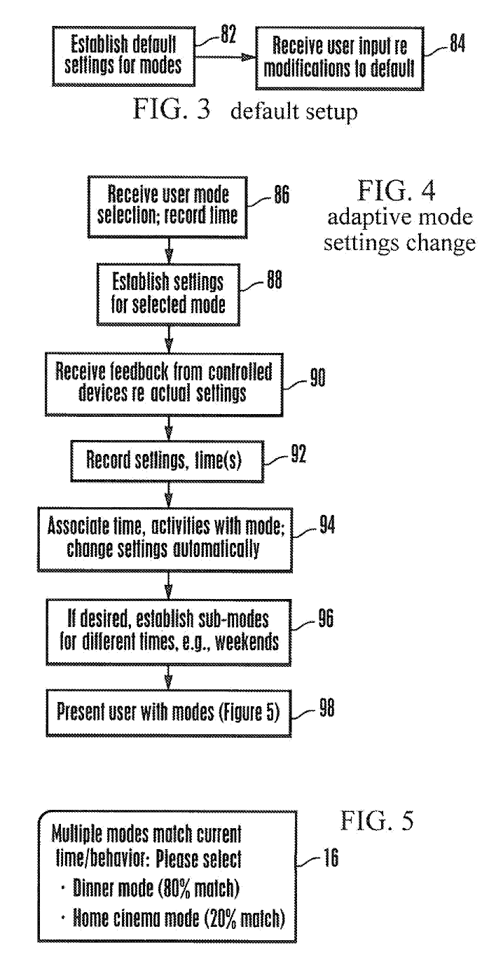

Now referring to FIG. 3, at block 82 modes and default settings therefore are established by, e.g., the manufacturer of the TV 12. Then, at block 84 user input is received from, e.g., the remote control 40 to modify the default settings.

Subsequently, as shown in FIG. 4 the settings in FIG. 2 may be automatically modified by the TV processor 18 by observing users' behaviors while in various modes. Starting at block 86, the TV receives user selections via, e.g., the UI of FIG. 2 of mode selection. The time of the selection may be recorded by the TV. At block 88 the settings corresponding to the selected mode are established.

Proceeding to block 90, user feedback is received and collected from one or more of the controlled devices regarding actual settings input by the user to the devices. As an example, suppose that from Monday to Friday, a user usually arrives home at 6 pm as indicated by a door lock sensor 80 of a security appliance controller, where this event is saved in a storage media and later can be conveyed to the TV processor 18. Suppose further that the user typically begins cooking at 6:30 pm as indicated by a temperature sensor of an oven controller, with the TV being turned on by the user just after user opens the door. Suppose further that the TV is typically tuned by the user to a favorite channel, e.g., evening news.

Accordingly, at block 94 the user behaviors and times of the behaviors are recorded by the TV and the home mode adjusted accordingly. The information may be stored and maintained in a database in the TV to generate and/or change each setting and user profiles adaptively. Using the example above, the “party hour” mode settings might be automatically invoked at 6 pm or at such time as the door lock sensor indicates the door has been opened, with the “dinner” mode settings automatically switched to at 6:30 pm or upon activation of the oven as indicated by an oven controller temperature sensor. Additionally, if a user more than M times changes an individual setting while in a particular mode, e.g., repeatedly dims lights that are otherwise set to “fully on”, the TV processor 18 automatically changes the setting from its current value to the value repeatedly changed to by the user.

Other devices with control sensors can be automatically adjusted based on current user activities, e.g., switch to dinner mode at 7:30 pm. If the TV processor 18 accesses not only a clock but an electronic calendar as well, at block 96 mode settings can be modified or created for user behaviors observed during weekends with the corresponding settings invoked only during weekend days.

Additionally, correlations between observed user behaviors as indicated by the various system sensors and user inputs can be used to predict user preferences based on probabilities and presented to users for their choices. For example, when a particular user input or behavior occurs that in the past has been correlated to multiple mode selections, as indicated at block 98 in FIG. 4 and as shown in FIG. 5 the TV processor 18 can prompt users with multiple choices based on the correlations. In FIG. 5, for example, a behavior, e.g., unlocking the door in the evening, has been followed 80% of the time with entry into the “dinner” mode from the UI of FIG. 2 and 20% of the time with entry into the “home cinema” mode, with the UI of FIG. 5 consequently listing both options so that the user may select one using, e.g., the remote control 40 of FIG. 1.

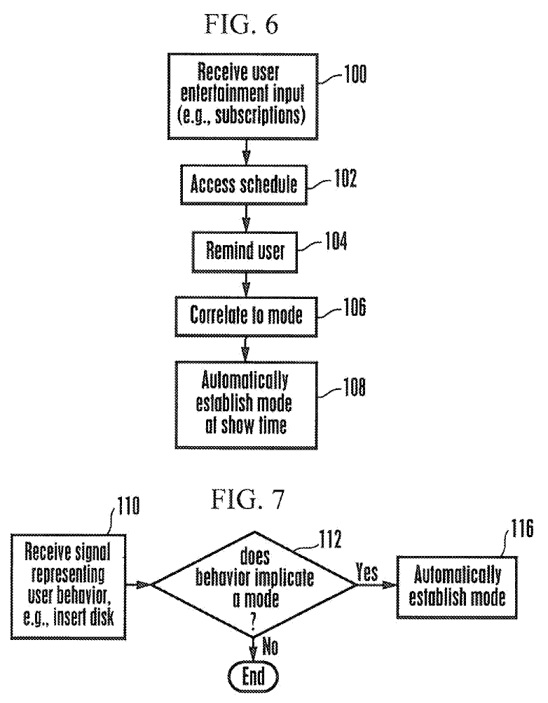

FIG. 6 shows that mode establishment and mode settings can be further adjusted to adapt to user behavior or input based on information from the Internet or an electronic program TV guide. For example, at block 100 the TV processor 18 can receive a user subscription to a TV program or channel. At block 102 a schedule of shows (e.g., an EPG) can be accessed to determine when the subscribed-to program is available and at block 104 the user reminded (e.g., by text messages or messages on the TV display) that the show is upcoming. Moreover, at block 106 the subscription may be correlated to a mode and the mode automatically established at block 108 at the time the program is broadcast or received. Thus, for example, the “home cinema” mode may be automatically established at the beginning of a subscribed-to show as indicated by the EPG and the TV 12 automatically tuned to the subscribed-to show.

FIG. 7 shows that the correlation between user behaviors and modes may be based on additional user actions sensed at block 110, for instance, the insertion of a disk into the home theater 26. It may be determined at decision diamond 112 whether the sensed behavior implies a particular mode, in this case, “home cinema” mode. The determination may be made based on preprogrammed heuristics or based on learned heuristics. As one example of the latter, suppose every time the user inserts a disk into the home theater 26, within a few minutes before or after the insertion the TV processor 18 observes that the UI of FIG. 2 is invoked and the mode changed to “home cinema”. Should a pattern of N such combined activities (an activity followed by a mode selection within a predetermined time window of the activity) be observed then a correlation is made which is used at decision diamond 112 for the next-observed specimen activity, e.g., for the next time a disk is inserted into the home theater. In any case, a negative answer at decision diamond 112 causes the logic of FIG. 7 to end at state 114; otherwise, the mode corresponding to the activity is established at block 116.

As a more advanced control technique for home theater mode, the appliance settings can be dynamically changed according to the theme of a movie which is being playing. For example, if a movie has a thriller theme, the lighting system may be further dimmed or turned off to create a darker environment; if a movie is a story with winter theme (e.g. snowing), the cooling system may further reduce the temperature of the room. The theme information of a movie can be collected from a disc player and sent to TV for correlation and processing to adjust settings of the lighting, temperature control and other appliances.

While the particular ADAPTIVE USER PROFILING FOR TV-CENTRIC HOME AUTOMATION SYSTEM is herein shown and described in detail, it is to be understood that the subject matter which is encompassed by the present invention is limited only by the claims.

What is claimed is:

1. System comprising:
a TV display;
a TV processor controlling the display and accessing a computer readable storage medium;
a control communication interface communicating with the TV processor;
a lighting controller controlling energization and/or brightness of one or more lamps in a home, the TV processor communicating with the lighting controller using the control communication interface to control the lighting controller to establish settings for the lamp;
a home theater controller controlling at least one home theater component and communicating with the TV processor through the control communication interface, the TV processor controlling the home theater controller to establish at least one setting for a home theater;
a room temperature controller controlling temperature of at least one room in a home in which the TV processor is disposed, the TV processor communicating with the room temperature controller using the control communication interface to control the room temperature controller to establish temperature settings; wherein
the TV processor adapts the settings for the lamp and/or the setting for the home theater and/or the temperature settings based on user behavior.

2. The system of claim 1, wherein the TV processor establishes respective home system modes and appliance settings for each controller for each mode and controls the controllers to establish the appliance settings for the respective appliance based on a mode selection input to the TV processor.

3. The system of claim 1, wherein the TV processor uses a wireless communication system to communicate with the controllers.

4. The system of claim 1, wherein the TV processor adapts to user behaviors noted as input to the TV processor and/or sensed by controller sensors and communicated to the TV processor, the TV processor adapting to user behaviors by automatically establishing a mode and/or by automatically changing at least one appliance setting of a mode.

5. The system of claim 1, wherein each mode includes respective appliance settings for a lighting controller and a home theater controller.

6. The system of claim 5, wherein the TV processor automatically commands appliance settings associated with a home theater mode to be established by the controllers in response to receiving indication of engagement of an optical storage disk with a disk player.

7. The system of claim 4, wherein the TV processor automatically establishes a mode based on time of day in response to observed user behavior.

8. System comprising:
TV display;
TV processor controlling the display and accessing a tangible computer readable storage medium bearing instructions to cause the processor to:
communicate with at least first and second home automation system controllers, the first controller controlling a home appliance that does not send to the TV processor or receive from the TV processor audio/video information;
establish respective home system modes and appliance settings for each controller for each mode; and
control the controllers to establish the appliance settings for the respective appliance based on a mode selection input to the TV processor.

9. The system of claim 8, wherein the processor uses a wireless communication system to communicate with the controllers.

10. The system of claim 8, wherein the first controller controls at least one of: lights in a dwelling, home security system components, a refrigerator, a stove, a heating system, a cooling system, a speaker system.

11. The system of claim 8, wherein the TV processor adapts to user behaviors noted as input to the TV processor and/or sensed by controller sensors and communicated to the TV processor, the TV processor adapting to user behaviors by automatically establishing a mode and/or by automatically changing at least one appliance setting of a mode.

12. The system of claim 8, wherein each mode includes respective appliance settings for a lighting controller and a home theater controller.

13. The system of claim 12, wherein the TV processor automatically commands appliance settings associated with a home theater mode to be established by the controllers in response to receiving indication of engagement of an optical storage disk with a disk player.

14. The system of claim 12, wherein the TV processor automatically establishes a mode based on time of day in response to observed user behavior.

15. TV comprising:
TV display;
processor communicating with the TV display;
computer readable storage medium accessible to the processor and bearing logic to cause the processor to:
present on the display a user interface (UI) listing two or more home modes, each mode being correlated to plural settings associated with respective plural home appliances;
receive user input through the UI representing user selection of a selected home mode; and
automatically establish the settings associated with the selected home mode.

16. The TV of claim 15, wherein the logic further causes the TV processor to receive user input other than through the UI to establish a mode along with the respective settings thereof.

17. The TV of claim 16, wherein the user input other than through the UI to establish a mode along with the respective settings thereof is engagement of a disk with a disk player.

18. The TV of claim 16, wherein the user input other than through the UI to establish a mode along with the respective settings thereof is input of a TV subscription order.

19. The TV of claim 15, wherein at least one home appliance does not send audio/video information to the TV processor or receive audio/video information there from.

20. System comprising:
TV display;
TV processor controlling the display and accessing a tangible computer readable storage medium bearing instructions to cause the processor to:
communicate with at least a first home automation system controller, the first controller controlling a home appliance that does not send to the TV processor or receive from the TV processor audio/video information;
establish at least one appliance setting of the appliance based at least in part on a theme of a program being displayed on the TV display.
